(19) United States
(12) Patent Application Publication
(10) Pub. No.: US 2002/0091450 A1
(43) Pub. Date: Jul. 11, 2002

(54) Device for supporting partial reading

(76) Inventor: Peterson Lu, Kaohsiung (TW)

Correspondence Address: J.C. Patents, Inc., 1340 Reynolds Ave., Suite 114, Irvine, CA, 92614, US

(21) Appl. No.: 09/790,948

(22) Filed: Feb. 22, 2001

(30) Foreign Application Priority Data
Jan. 11, 2001 (TW) 90100596

(51) Int. Cl. G05B 19/18

(52) U.S. Cl. 700/2

(57) ABSTRACT

A device inside a chipset for supporting partial reading such that a central processing unit is able to determine the different bit access bandwidth of a plurality of peripheral devices and act accordingly. The device is constructed from a plurality of register groups. Each register group has a storage spacer for housing partial read base address bits, partial read enable bits, partial read transfer size bits, priority bits and partial read offset bits. These bits are used to record or determine conditions for executing a partial reading.

### CROSS-REFERENCE TO RELATED APPLICATION

This application claims the priority benefit of Taiwan application serial no. 90100596, filed Jan. 11, 2001.

### BACKGROUND OF THE INVENTION

1. Field of Invention

The present invention relates to a reading device for a central processing unit. More particularly, the present invention relates to a device for detecting a plurality of peripheral devices each having a set of access bits so that partial reading can be carried out by a central processing unit.

2. Description of Related Art

FIG. 1 is a diagram showing the conventional architectural structure of a personal computer. As shown in FIG. 1, a central processing unit (CPU) 10 inside the computer is connected to external-supported peripheral devices via a chipset 12. The chipset 12 consists of a south bridge 14 and a north bridge 16. The south bridge 14 is responsible for inputting/outputting from hard drives or floppy drives while the north bridge is responsible for integrating the CPU and RAM. External peripheral devices include, for example, a monitor 18, a hard drive 20, a universal asynchronous receiver/transmitter (UART) 22 and so on. In current years, rapid advances in technology have increased the operating speed of the CPU manyfold. For example, a CPU routinely accesses a chipset with 64-bit data word transmission. However, subject to practical constraints, most peripheral devices rarely have a bit access width identical to that of the CPU. If a CPU has no support for partial reading, there is no way for a chipset to find out what bytes are needed by a device such as an input/output device (capable of accessing 8 bits, 16 bits or 32 bits at a time). Consequently, problems may occur leading to failure especially for those devices that need to utilize a read cycle to reset specific registers or for most input/output devices that have a non-prefetchable status.

### SUMMARY OF THE INVENTION

Accordingly, one object of the present invention is to provide a device and a method capable of supporting partial reading so that a central processing unit (CPU) can clearly decide which particular bytes to read, thereby avoiding readout problems.

To achieve these and other advantages and in accordance with the purpose of the invention, as embodied and broadly described herein, the invention provides a device for supporting partial reading. The device is incorporated into a chipset so that the set of access bits demanded by each of a plurality of peripheral devices can be determined. Ultimately, a central processing unit (CPU) can perform a partial reading of the peripheral devices. The device is constructed using groups of registers. Each group of registers includes partial read base address bits, partial read enable bits, partial read transfer size bits, priority bits and partial read offset bits. The partial read base address bits record a partial read base address. The partial read enable bits are used to determine if a partial reading is required. The partial read transfer size bits are used to determine size of the bit access. The priority bits are used for setting the priority of bit access for different peripheral devices. The partial read offset bits record the size of offset for a particular partial read operation.

Each group of registers comprises a partial read base address register and a partial read control and offset register. The partial read base address register includes the partial read base address bits. The partial read control and offset register includes the partial read enable bits, the partial read transfer size bits, the priority bits and the partial read offset bits. The partial read base address register and the partial read control and offset register both contain the same number of bits, for example 32 bits. The number of bits in the partial read enable bit position, the partial read transfer size bit position, the priority bit position and the partial read offset bit position are 1, 1, 3 and 10 respectively. In addition, the peripherals that can utilize the device of this invention includes 8-bit, 16-bit and 32-bit floppy disks, hard disks or input/output ports.

This invention also provides a method for supporting partial reading that can be applied to a central processing unit for reading from a plurality of peripheral devices each using a different number of access bits. At least a first group of registers is provided. The first group of registers records the partial read base address of the peripheral devices with transfer size lower than that of the CPU. The first group of registers is also used to determine partial read enable status, bit access transfer size, bit access priority as well as to record the offset of the partial read. According to the partial read base address and the range of the partial read offset size, at least a second group of registers is provided. The second group of registers records the partial read base address of the peripheral devices with transfer size lower than that of the first group. The second group of registers is also used to determine partial read enable status, bit access transfer size, bit access priority as well as to record the offset of the partial read.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing the conventional architectural structure of a personal computer;

FIG. 2 is a diagram showing a CPU and a plurality of peripheral devices connected to a device that supports partial reading according to one preferred embodiment of this invention;

FIG. 3 is a diagram showing in detail the content in one of the register groups shown in FIG. 2, and

FIG. 4 is a diagram showing an example of the method of applying the partial read support device in an actual address space.

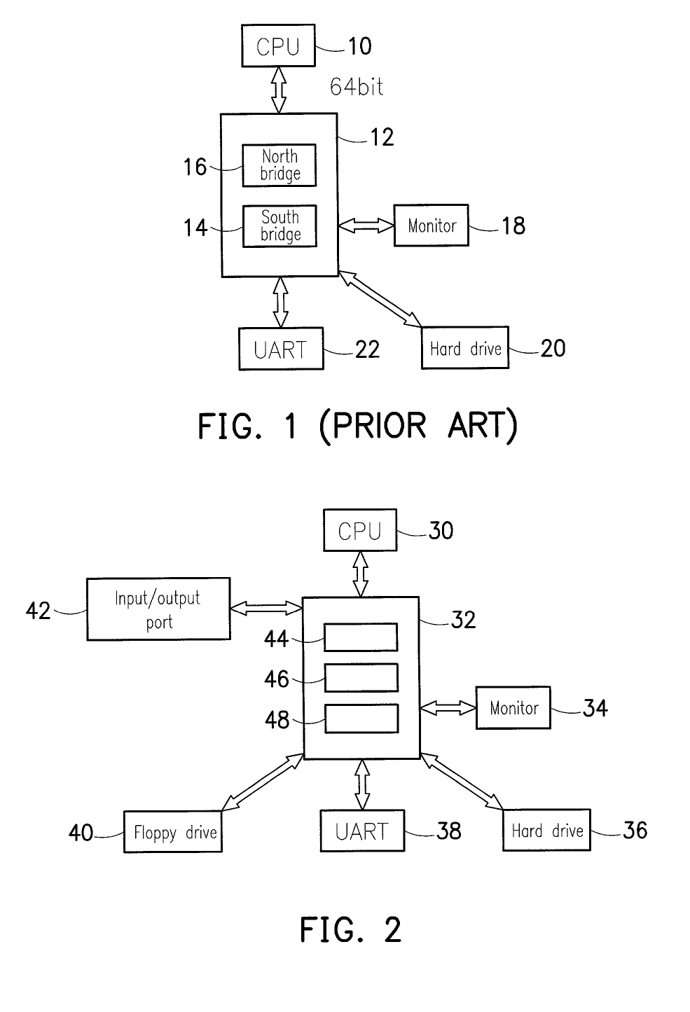

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a diagram showing a CPU and a plurality of peripheral devices connected to a device that supports partial reading according to one preferred embodiment of this invention. In FIG. 2, the device for supporting partial reading is installed inside a chipset 32. The chipset 32 is coupled to a CPU 30 and a plurality of peripheral devices (for example, a monitor 34, a hard drive 36, a UART 38, a floppy drive 40 and an input/output port 42). Since the peripheral devices may have different access bandwidths (for example, 8-bit, 16-bit and 32-bit), the CPU 30 needs to determine the attributes of all the peripheral devices before correct data can be retrieved from partial reading. Hence, a plurality of register groups such as 44, 46 and 48 are shown inside the chipset 32. Each group of registers (44, 46 and 48) contains partial read base address bits, partial read enable bits, partial read transfer size bits, priority bits and partial read offset bits.

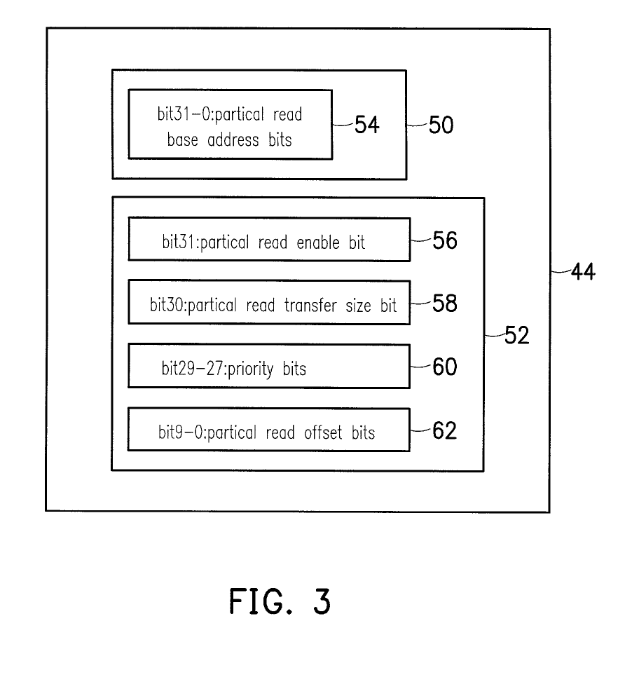

To explain the structure of each register group in more detail, an example of a group of registers is singled out. FIG. 3 is a diagram showing in detail the content in one of the register groups 44 shown in FIG. 2. As shown in FIG. 3, the register group 44 includes a partial read base address register 50 and a partial read control and offset register 52.

The partial read base address register 50 has a 32-bit (bit 31˜0) segment for holding partial read base address bits 54. The partial read base address bits record the partial base (starting) address. Similarly, the partial read control and offset register 54 has a 32-bit segment for holding a variety of bits. The bits held by the partial read control and offset register 54 include one (bit 31) partial read enable bit 56, one (bit 30) partial read transfer size bit 58, three (bit 29˜27) priority bits and ten (bit 9˜0) partial read offset bits 62.

The partial read enable bit 56 is used for determining if the attribute of a particular peripheral device requires partial reading or not. The partial read transfer size bit 58 is used to indicate the size of each partial reading operation. For example, logic ‘1’ in the bit position implies a 16-bit transmission while logic ‘0’ implies an 8-bit transmission. The priority bits 60 are mainly used to order the operating sequence of the register group. The priority bits 60 of all group may be preset to save the installation of a priority comparator. The partial read offset bits 62 record size of the partial read offset. In other words, the size of each partial reading is determined by the partial read offset bits 62.

The following is a detailed description of the method of operation of the partial reading device. First, a chipset having a plurality of register groups is provided. Each register group has a group of registers for recording the partial read base address, for determining partial read status, for indicating bit transfer size, for setting operating priority of this group and recording partial read offset size. If the partial read status is positive (partial read enable bit is set to logic ‘1’) and the CPU address is between the base address and the base address+offset, the partial read function of the group of registers is in an effective state.

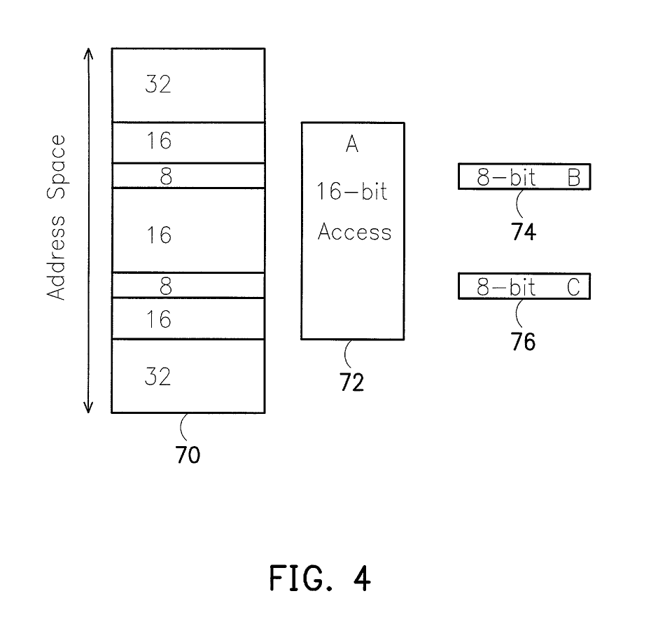

FIG. 4 is a diagram showing an example of the method of applying the partial read support device in an actual address space. As shown in FIG. 4, an address space 70 is provided. The address space 70 includes, from top to bottom, a 32-bit segment, a 16-bit segment, an 8-bit segment, a 16-bit segment, an 8-bit segment, a 16-bit segment, and a 32-bit segment, altogether seven different bit access segments for peripheral devices. To use this invention, the first group of registers A 72 may be used as a peripheral device range for peripherals of access bandwidth equal or less than 16 bits (16-bit, 8-bit, 16-bit, 8-bit, 16-bit range in FIG. 4) to record partial read base address, to determine the partial read enable status, bit access transfer size, priority of this group and to record partial read offset function. The partial read base address and partial read offset of the peripheral devices are next determined. At least a second group of registers is also provided. For example, two groups of registers (B and C) 74 and 76 are provided to record two 8-bit peripheral devices. The operation priority is set by the priority bit in each group, for example, in this embodiment, C>B>A. The undefined regions are regarded as 32-bit access. In practice, because the distribution is continuous, each device requires no more than three groups. Hence, as long as group registers defined according to this invention are used to form a reading channel with priority, the partial reading problem can be resolved.

In summary, one major aspect of this invention is the implementation of partial reading for a plurality of peripheral devices each having a different bit access bandwidth without relying on sophisticated hardware (registers) or the need for any software changes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A device inside a chipset for supporting partial reading, wherein the device is capable of determining the different bit access bandwidth of a plurality of peripheral devices so that a central processing unit can execute partial reading on each peripheral device, comprising:
a plurality of register groups, wherein each register group further comprises:
partial read base register bits for recording partial read base address;
partial read enable bits for determining partial read status;
partial read transfer size bits for indicating size of each bit access transmission;
priority bits for setting the operating sequence of the different bit access bandwidth peripheral devices; and
partial read offset bits for recording size of the partial read offset.

2. The device of claim 1, wherein each register group is constructed from a partial read base address register and a partial read control and offset register, the partial read base address register contains the partial read base address bits, and the partial read control and offset register contains the partial read enable bits, the partial read transfer size bits, the priority bits and the partial read offset bits.

3. The device of claim 2, wherein the partial read base address register and the partial read control and offset register have an identical number of bits.

4. The device of claim 3, wherein the number of bits in both the partial read base address register and the partial read control and offset register is 32.

5. The device of claim 4, wherein the number of bits used in defining partial read enable, partial read transfer size, priority and partial offset are 1, 1, 3, and 10 respectively.

6. The device of claim 1, wherein the peripheral devices with different bit access bandwidth includes bandwidth of 8 bit, 16 bit and 32 bit.

7. The device of claim 1, wherein the peripheral devices include floppy disk drives, hard drives and input/output ports.

8. A method for supporting partial reading by a central processing unit with respect to a plurality of peripheral device each having a different bit access bandwidth, comprising the steps of:
providing at least a first group of registers for recording the partial read base address of the peripheral devices lower than a first standard bit access number, for determining partial read status, bit access transfer size, bit access priority and for recording the offset of the partial read; and
providing at least a second group of registers according to the partial read base address and the range of the partial read offset size for recording the partial read base address of the peripheral devices lower than a second standard bit access number, for determining partial read status, bit access transfer size, bit access priority and for recording the offset of the partial read.
